(19) United States
(12) Patent Application Publication
(10) Pub. No.: US 2014/0077922 A1
(43) Pub. Date: Mar. 20, 2014

(54) CONTACTLESS POTENTIOMETER

(71) Applicant: Nidec Servo Corporation, Kiryu-city (JP)

(72) Inventors: Masahiro HORIGUCHI, Kiryu-shi (JP); Masaru YAMANOI, Kiryu-shi (JP)

(73) Assignee: NIDEC SERVO CORPORATION, Kiryu-city (JP)

(21) Appl. No.: 14/024,843

(22) Filed: Sep. 12, 2013

(30) Foreign Application Priority Data
Sep. 14, 2012 (JP) 2012-202241

(51) Int. Cl. H01C 10/10

(52) U.S. Cl. CPC H01C 10/103
USPC 338/12

(57) ABSTRACT

A contactless potentiometer includes a shaft and a magnet rotatable together with the shaft and detects a rotational angle of the shaft corresponding to a change in magnetic fields caused by the rotation of the magnet, the magnet being held in a tip end portion of the shaft. The potentiometer includes a cover member attached to a housing at a tip end side of the shaft and arranged to define a closed sensor area between the cover member and the housing, and a circuit board mounted to the cover member at a side of the sensor area in a perpendicular or substantially perpendicular relationship with the shaft. The cover member includes a recess portion arranged on a surface of the cover member facing the circuit board, the recess portion cooperating with the circuit board to define a component-mounting spare space.

### BACKGROUND OF THE INVENTION

1. Field of the Invention

The present invention relates to a magnetic contactless potentiometer arranged within an electric device or an industrial device and used to detect a rotation position.

2. Description of the Related Art

Conventionally, a contactless potentiometer used as an angular sensor is known. As disclosed in, e.g., Japanese Patent Application Publication No. 2006-242915 (JP2006-242915A), there is available a contactless potentiometer in which a disc-shaped magnet fixed to a shaft is formed into a substantially cylindrical columnar shape such that the outer peripheral portion of the magnet has a thickness varying in the circumferential direction. In this contactless potentiometer, the rotational position of the shaft is detected by changing an output voltage of a Hall element depending on the variation of the thickness of the magnet facing the Hall element arranged at one side of the magnet.

As disclosed in, e.g., Japanese Patent Application Publication No. H08-193802 (JP08-193802A), there is also available another potentiometer. In this potentiometer, a magnet is attached to the tip end of a shaft either directly or through a thermal expansion-and-contraction portion. A pair of magnetic resistance elements is arranged so as to axially face the magnet. The intensity of magnetic fields acting on the magnetic resistance elements is changed depending on the rotational position of the magnet rotating together with the shaft, whereby the resistance values of the magnetic resistance elements are made variable. The rotational angle of the shaft can be found from the variation of an output voltage caused by the rotating motion of the shaft.

In the conventional potentiometer disclosed in JP2006-242915A, the magnet rotating together with the shaft needs to be formed into such a shape that the outer peripheral portion thereof has a thickness varying in the circumferential direction. This poses a drawback in that the magnet is special in shape and is time-consuming and expensive to manufacture. Moreover, there is a problem in that the overall size of the potentiometer becomes larger because the Hall element is arranged around the outer peripheral portion of the magnet.

In case of the potentiometer disclosed in JP08-193802A, the permanent magnet attached to the tip end of the shaft and the two magnetic resistance elements arranged so as to face the permanent magnet can be arranged along the axial direction of the shaft. Therefore, unlike the potentiometer disclosed in JP2006-242915A, the overall size of the potentiometer does not become larger. There is no need to use a permanent magnet having a special shape. This makes it possible to make the potentiometer small in size and less expensive. However, the potentiometer disclosed in JP08-193802A is only configured such that the two magnetic resistance elements are arranged above a magnetic yoke existing on the bottom surface of a housing and the lead terminals of the magnetic resistance elements are led out from the housing. For this reason, it is only possible to obtain the output signals of the two magnetic resistance elements from the potentiometer. The signal (voltage signal), which depends on the rotational angle of the shaft, needs to be generated by an external processing circuit. This poses a problem in that the external device becomes complex.

In case of the potentiometer disclosed in JP08-193802A, it is thinkable that a circuit board to which the respective terminals of the two magnetic resistance elements are connected to form a signal processing circuit is accommodated within the housing of the potentiometer. However, in this case there is a disadvantage in that it is not easy to secure a space for the accommodation of the circuit board because the two magnetic resistance elements are arranged between the permanent magnet and the magnetic yoke facing each other. If there is a functional demand, e.g., a demand for a countermeasure against noises such as electromagnetic waves or the like which may affect the output signal of the potentiometer, the circuit board needs to be replaced with a new one reflecting a change in the circuit configuration. Different kinds of potentiometers have to be prepared to meet different specifications. This is disadvantageous in that the manufacturing efficiency of the potentiometer becomes lower.

### SUMMARY OF THE INVENTION

Preferred embodiments of the present invention provide a contactless potentiometer capable of being reduced in size, capable of accommodating not only a rotational angle detection element but also a circuit that processes a detection signal supplied from the detection element, and capable of coping with an additional functional demand without having to significantly change the potentiometer.

According to one preferred embodiment of the present invention, a contactless potentiometer includes a shaft and a magnet rotatable together with the shaft and serves to detect a rotational angle of the shaft corresponding to a change in magnetic fields caused by the rotation of the magnet, the potentiometer including: a housing arranged to rotatably support the shaft through a bearing, the magnet held in a tip end portion of the shaft; a cover member attached to the housing at a tip end side of the shaft and arranged to define a closed sensor area between the cover member and the housing, the tip end portion of the shaft extending into the sensor area; and a circuit board mounted to the cover member at a side of the sensor area in a perpendicular or substantially perpendicular relationship with the shaft, the circuit board including a sensor-area-side surface on which a magnetic angle-detecting sensor IC is mounted so as to face the magnet, wherein the cover member includes a recess portion arranged on a surface of the cover member facing the circuit board, the recess portion cooperating with the circuit board to define a component-mounting spare space.

With the contactless potentiometer according to a preferred embodiment of the present invention, the magnet is held in the tip end portion of the shaft supported on the housing and is arranged within the sensor area. The sensor IC is mounted on the circuit board attached to the sensor-area-side surface of the cover member in a facing relationship with the magnet. It is therefore possible to arrange the magnet and the sensor IC along the axial direction of the shaft. Unlike with a conventional potentiometer, there is no likelihood that the overall size of the potentiometer becomes larger in the radial direction of the shaft. The circuit board is mounted to the cover member. The peripheral circuit of the sensor IC mounted on the circuit board can also be mounted on the circuit board. It is therefore possible to output an output signal indicating the rotational angle of the shaft. In particular, the recess portion is arranged on the surface of the cover member facing the circuit board and is arranged to face the circuit board. Therefore, a component can be mounted on the surface of the circuit board facing the recess portion. The circuit configuration relating to the sensor IC can be appropriately changed without having to change the structures of the circuit board, the housing and the cover member. This makes it possible to cope with every change of the specifications.

The contactless potentiometer of preferred embodiments of the present invention is preferably installed within an electric device or an industrial device to detect the rotational position, for example. Since the sensor area can be hermetically sealed, the contactless potentiometer can be used in an outdoor area with a disadvantageous working environment requiring a dust proof and water proof characteristic.

The above and other elements, features, steps, characteristics and advantages of the present invention will become more apparent from the following detailed description of preferred embodiments of the present invention made with reference to the attached drawings. The accompanying drawings are presented merely for the sake of illustration and are not intended to limit the present invention.

### BRIEF DESCRIPTION OF THE DRAWINGS

FIG. 1 is a sectional side view showing a contactless potentiometer according to a first preferred embodiment of the present invention.

FIG. 2 is a front view of the contactless potentiometer shown in FIG. 1.

FIG. 3 is a diagram showing the wire connection in a circuit board of the contactless potentiometer shown in FIG. 1.

FIG. 4 is a sectional side view showing a contactless potentiometer according to a second preferred embodiment of the present invention.

FIG. 5 is a front view of the contactless potentiometer shown in FIG. 4.

FIG. 6 is a sectional side view showing a contactless potentiometer according to a third preferred embodiment of the present invention.

### DETAILED DESCRIPTION OF THE PREFERRED EMBODIMENTS

Certain preferred embodiments of the present invention will now be described with reference to the drawings.

### First Preferred Embodiment

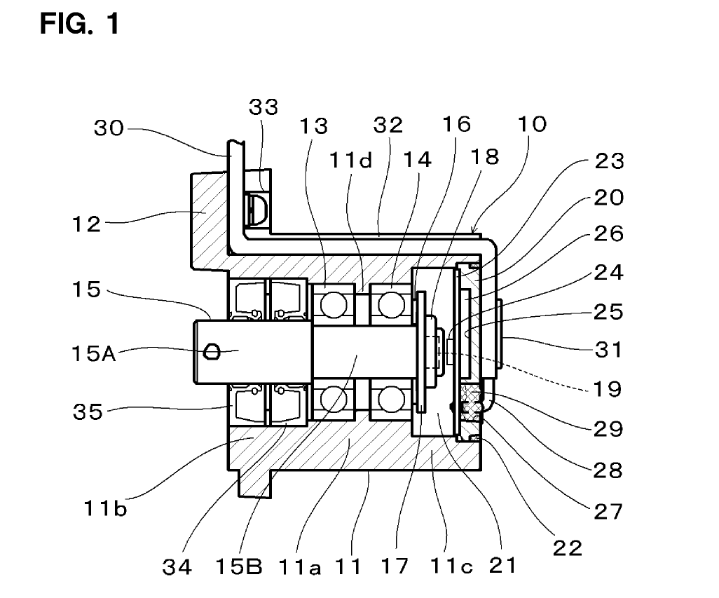

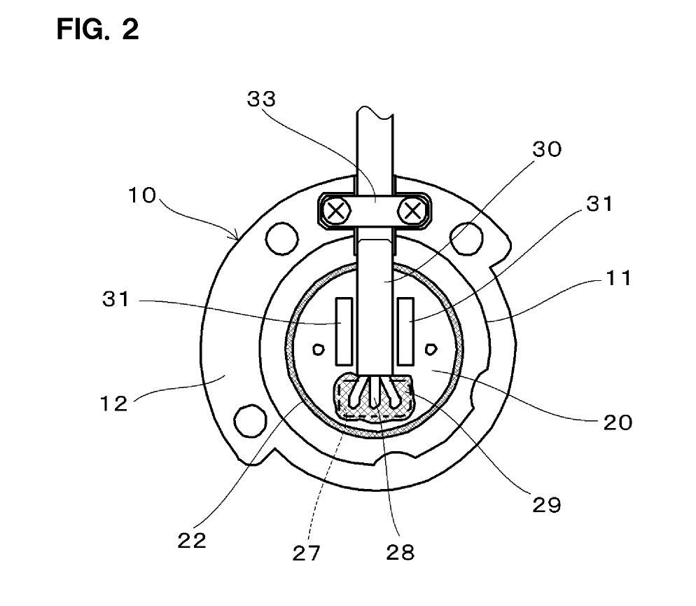

A contactless potentiometer according to a first preferred embodiment of the present invention will be described with reference to FIGS. 1 through 3. FIG. 1 is a sectional view of the contactless potentiometer taken along an axis of a shaft. FIG. 2 is a front view of the contactless potentiometer. The contactless potentiometer preferably includes a housing 10 as an outer shell. The housing 10 preferably includes a cylindrical body portion 11 and a flange portion 12 integrally defined with a base of the body portion 11. The housing 10 is preferably made of, e.g., a non-magnetic metallic material or a resin material. The body portion 11 preferably includes a middle bearing holder portion 11a, a base-side sealing portion 11b having an inner diameter a little larger than an inner diameter of the bearing holder portion 11a, and a tip-end-side sensor portion 11c having an inner diameter larger than an inner diameter of the sealing portion 11b. A pair of bearings 13 and 14 defined by, for example, ball bearings is preferably arranged inside the bearing holder portion 11a. A shaft 15 is rotatably supported by the bearings 13 and 14. A ring-shaped step portion 11d protruding radially inward from the bearing holder portion 11a is preferably positioned between the outer races of the bearings 13 and 14.

The shaft 15 is made of, e.g., a non-magnetic metallic material, and preferably includes a base-side large diameter portion 15A and a tip-end-side smaller diameter portion 15B, both of which adjoin each other in a middle or substantially middle axial position of the shaft 15. A thread is preferably provided on the outer circumferential surface of a tip end portion of the smaller diameter portion 15B. The smaller diameter portion 15B of the shaft 15 is inserted through the inner races of the bearings 13 and 14 such that the tip end portion thereof protrudes beyond the bearing 14. A ring-shaped leaf spring 16 and a ring-shaped spacer 17 are preferably fitted to the tip end portion of the smaller diameter portion 15B protruding beyond the bearing 14. Then, a nut 18 is threadedly coupled to the thread of the tip end portion of the smaller diameter portion 15B. Consequently, the shaft 15 is supported on the body portion 11. At this time, the shoulder portion of the large diameter portion 15A of the shaft 15 facing the smaller diameter portion 15B contacts the base-side end surface of the inner race of the bearing 13. The mutually-facing end surfaces of the outer races of the bearings 13 and 14 contact the ring-shaped step portion 11d. Therefore, if the nut 18 is threadedly coupled by a suitable tightening force in a state that the leaf spring 16 contacts the end surface of the inner race of the bearing 14, a constant pressure preload is applied to the bearings 13 and 14 by the leaf spring 16. Thus, the shaft 15 is supported on the body portion 11 without being loosened. The leaf spring 16, the spacer 17 and the nut 18 are preferably made of, e.g., a magnetic metallic material.

As is apparent from the above description, the tip end portion of the smaller diameter portion 15B of the shaft 15 protruding away from the bearing 14 is arranged inside the sensor portion 11c of the body portion 11. A circular or substantially circular recess portion opened on the tip end of the shaft 15 is preferably defined in the tip end portion of the smaller diameter portion 15B in a concentric relationship with the shaft 15. A disc-shaped magnet 19 is concentrically embedded in the circular or substantially circular recess portion and is preferably fixedly secured in place by, e.g., an adhesive agent. The magnet includes an outer diameter that is equal or substantially equal to an inner diameter of the circular or substantially circular recess portion. The magnet 19 is preferably made of, e.g., a sintered neodymium magnet. Two magnetic poles magnetized in a semicircular or substantially semicircular shape are arranged along the circumferential direction of the magnet 19.

The opening of the body portion 11 defined at the tip end side of the sensor portion 11c is preferably closed by a circular or substantially circular cover member 20. A closed sensor area 21 in which the tip end portion of the shaft 15 arranged is defined inside the sensor portion 11c. An adhesive agent 22 is filled between the inner surface of the open end of the sensor portion 11c and the outer circumferential surface of the cover member 20 over the entire circumference, so as to increase the air-tightness of the sensor area 21. A double-side-printed circular or substantially circular circuit board 23 is preferably attached to the whole or substantially whole surface of the cover member 20 facing the sensor area 21, i.e., the surface of the cover member 20 facing the tip end portion of the shaft 15, in a perpendicular or substantially perpendicular relationship with the shaft 15. A magnetic angle-detecting sensor IC 24 facing the magnet 19 is preferably mounted to the sensor-area-side surface of the circuit board 23 in a position facing the tip end portion of the shaft 15, namely to the central region of the circuit board 23. As the sensor IC 24, it may be possible to use, e.g., a type number MLX90316 produced by Melexis, Inc.

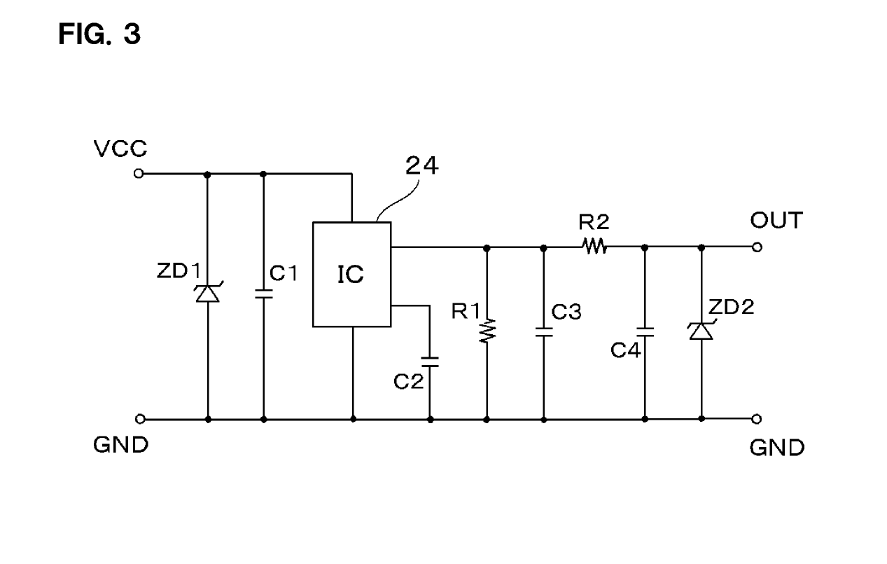

FIG. 3 shows an example of a preferred embodiment of a processing circuit arranged to obtain a signal indicating the rotational angle of the magnet 19 from an output signal of the sensor IC 24. In FIG. 3, reference symbols ZD1 and ZD2 designate zener diodes. Reference symbols C1, C2, C3, and C4 designate capacitors. Reference symbols R1 and R2 designate resistors. Reference symbol VCC designates a power supply terminal. Reference symbol GND designates a ground terminal. Reference symbol OUT designates an output terminal. Different kinds of electronic components included in the processing circuit, including the sensor IC 24, are preferably mounted to the sensor-area-side surface of the circuit board 23.

A recess portion 25 is preferably defined in the cover member 20 over a relatively broad extent including the central region of the cover member 20 in a confronting relationship with the circuit board 23. A closed component-mounting spare space 26 is preferably defined by the recess portion 25 and the circuit board 23. In case of adding a special option circuit other than the circuit shown in FIG. 3, e.g., a protection circuit arranged to perform a countermeasure against electromagnetic waves which may affect the output signal outputted from the output terminal OUT, the spare space 26 is used in mounting components on the circuit board 23 to define an option circuit.

A square or substantially-square lead wire guide hole 27 is preferably defined in the off-centered region of the cover member 20. Lead wires extending from the outside are passed through the guide hole 27 and are directly connected to a portion of the circuit board 23. The respective terminals VCC, OUT, and GND shown in FIG. 3 are arranged in the position of the circuit board 23 corresponding to the guide hole 27. The terminals VCC, OUT, and GND are preferably provided by through-holes. Three lead wires 28 extending from the outside are passed through the guide hole 27 and are inserted into the respective through-hole terminals of the circuit board 23. The lead wires 28 are preferably connected, by soldering, to the surface of the circuit board 23 on which the sensor IC 24 is mounted. After connecting the lead wires 28, a sealing material 29 is preferably filled in the guide hole 27, so as to hold the lead wires 28 in place and to maintain the air-tightness of the sensor area 21.

The three lead wires 28 are passed through a protective tube and are gathered into a single flat cable 30. The flat cable 30 is passed through between a pair of projections 31 protruding from the outer surface of the cover member 20 and is guided upward. The flat cable 30 is preferably guided to the flange portion 12 through a groove 32 axially defined on the upper surface of the body portion 11. The flat cable 30 is preferably restrained by a pressing plate 33 fixed to the flange portion 12 and is united with the housing 10.

In between the inner circumferential surface of the sealing portion 11b of the body portion 11 of the housing 10 and the outer circumferential surface of the large diameter portion 15A of the shaft 15, two oil seals 34 and 35 are preferably arranged side by side along the axial direction. The oil seals 34 and 35 prevent dust from infiltrating into the bearing holder portion 11a. In cooperation with the cover member 20, the oil seals 34 and 35 increase the sealing degree of the sensor area 21, so as to improve the dust proof and the water proof characteristics of the housing 10.

In the contactless potentiometer configured as above, the base of the large diameter portion 15A of the shaft 15 is preferably connected to a measurement target whose rotational angle is to be detected. The shaft 15 is rotated along with the rotation of the measurement target, such that the magnet 19 existing at the tip end of the shaft 15 is rotated to generate a change in magnetic fields. The sensor IC 24 facing the front surface of the magnet 19 detects the change in magnetic fields and is arranged to generate an output signal indicating the rotational angle of the shaft 15.

In the contactless potentiometer according to the first preferred embodiment, the sensor IC 24 is preferably arranged to axially face the magnet 19 provided in the tip end portion of the shaft 15. Therefore, as compared with the conventional potentiometer in which a sensor is arranged around the outer periphery of a magnet, the potentiometer of the present preferred embodiment does not become larger in diameter. Since the magnet 19 is embedded in the tip end portion of the shaft 15, it becomes possible to easily reduce the overall size of the potentiometer. The circuit board 23 is attached to the entire or substantially the entire surface of the cover member 20 that defines the sensor area 21 in cooperation with the housing 10. Different kinds of circuit components including the sensor IC 24 are mounted on one surface of the circuit board 23. This eliminates the need to prepare a special space for the accommodation of the circuit board 23. There is no likelihood that the potentiometer becomes larger in size.

In particular, the circuit board 23 attached to the cover member 20 is preferably defined by a double-side-printed board. The spare space 26 facing the circuit board 23 is secured by forming the recess portion 25 in the cover member 20. Therefore, when an effort is made to improve a function by providing a countermeasure against electromagnetic waves which may affect the output signal generated from a sensor, it is possible to additionally mount an option circuit on the circuit board 23 through the use of the spare space 26. This makes it possible to cope with the demand for an option circuit without making any structural changes. Thus, the versatility of the potentiometer becomes higher. In addition, if the circuit board 23 is defined by a double-side-printed board, the portions of the circuit board 23 to which the lead wires 28 are connected can be arranged in through-holes. This makes it possible to increase the connection reliability of the lead wires 28.

### Second Preferred Embodiment

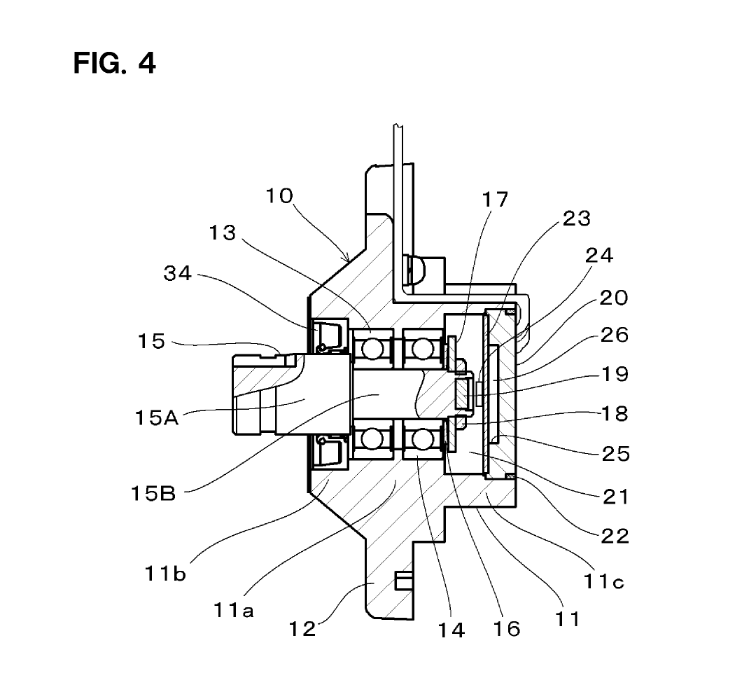

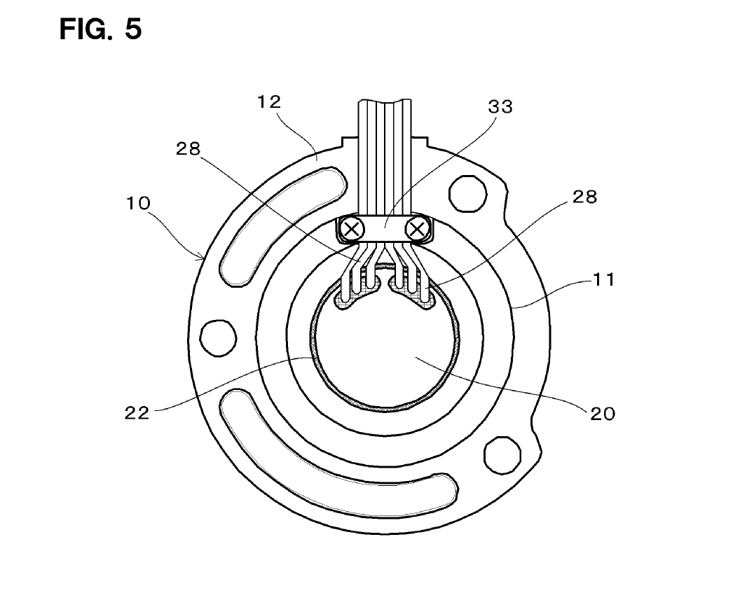

FIGS. 4 and 5 show a contactless potentiometer according to a second preferred embodiment of the present invention. FIG. 4 is a sectional view of the contactless potentiometer taken along the axis of a shaft. FIG. 5 is a front view of the contactless potentiometer. In FIGS. 4 and 5, the same reference symbols as used in FIGS. 1 and 2 designate identical or substantially equivalent components or elements.

The housing 10 preferably includes the body portion 11 and the flange portion 12. Unlike the first preferred embodiment, the flange portion 12 is preferably integrally defined with the middle bearing holder portion 11a of the body portion 11 not the base of the body portion 11. The body portion 11 is larger in diameter than the body portion 11 of the first preferred embodiment. The shaft 15 preferably includes the base-side large diameter portion 15A and the tip-end-side middle diameter portion 15B. The smaller diameter portion 15B is supported by the bearings 13 and 14 arranged in the bearing holder portion 11a of the body portion 11. The nut 18 is threadedly coupled, preferably through the leaf spring 16 and the spacer 17, to the tip end portion of the smaller diameter portion 15B protruding into the sensor portion 11c of the body portion 11. Thus, the shaft 15 is rotatably supported on the body portion 11 with a constant pressure preload applied to the body portion 11. The circular or substantially circular recess portion is concentrically defined in the tip end portion of the smaller diameter portion 15B of the shaft 15. The disc-shaped magnet 19 is embedded in the circular or substantially circular recess portion.

The cover member 20 is attached to the sensor portion 11c of the body portion 11 of the housing 10 so as to cover the tip end opening of the sensor portion 11c. The closed sensor area 21 is preferably arranged inside the sensor portion 11c. The circular or substantially circular circuit board 23 is attached to the sensor-area-side surface of the cover member 20 over the whole or substantially the whole region of the cover member 20 in perpendicular or substantially perpendicular relationship with the shaft 15. The sensor IC 24 is preferably mounted to the central region of the circuit board 23 facing the magnet 19. Different kinds of electronic components defining a circuit arranged to process the signal supplied from the sensor IC 24 are mounted around the sensor IC 24. The recess portion 25 is preferably located in a partial region (central region) of the surface of the cover member 20 facing the circuit board 23. Thus, the component-mounting spare space 26 is defined between the cover member 20 and the circuit board 23.

In the circuit board 23 of the second preferred embodiment, preferably provided are two circuits arranged to process the signal supplied from the sensor IC 24. The angle signal indicating the rotational angle of the shaft 15 can be outputted in two ways. As shown in FIG. 5, two guide holes, through which lead wires 28 are extended to the circuit board 23, are preferably arranged at the upper portion of the cover member 20. Three lead wires 28 are passed through each of the guide holes and are connected to the circuit board 23, such that two output signals can be extracted to the outside. The two guide holes are preferably filled with sealing materials. The two-kinds of six lead wires 28, for example, coming from the cover member 20 are let out along a groove defined in the body portion 11 and the flange portion 12 and are guided to the outside. The intermediate extensions of the lead wires 28 are tied by a fixed pressing plate 33.

An oil seal 34 is preferably arranged between the inner circumferential surface of the sealing portion 11b of the body portion 11 of the housing 10 and the outer circumferential surface of the large diameter portion 15A of the shaft 15. The oil seal 34 preferably prevents or substantially prevents dust from infiltrating into the bearing holder portion 11a. In cooperation with the cover member 20, the oil seal 34 increases the sealing degree of the sensor area 21, so as to improve the dust proof and the water proof characteristics.

In the second preferred embodiment of the present invention, just like the first preferred embodiment of the present invention, the sensor IC 24 is arranged to axially face the magnet 19 provided in the tip end portion of the shaft 15. Therefore, as compared with a conventional potentiometer in which a sensor is arranged around the outer periphery of a magnet, the present potentiometer does not become larger in diameter. The circuit board 23 is preferably attached to the entire or substantially the entire surface of the cover member 20 that defines the sensor area 21 in cooperation with the housing 10. Different kinds of circuit components preferably including, for example, the sensor IC 24, are mounted on one surface of the circuit board 23. This eliminates a need to prepare a special space for the accommodation of the circuit board 23. There is no likelihood that the potentiometer becomes larger in size. In particular, the circuit board 23 attached to the cover member 20 is preferably defined by a double-side-printed board. The spare space 26 facing the circuit board 23 is secured by forming the recess portion 25 in the cover member 20. Therefore, when an effort is made to improve a function by providing a countermeasure against electromagnetic waves which may affect one or both of the two output signals generated from a sensor, it is possible to use the spare space 26. This makes it possible to cope with the demand for an option circuit without making any structural change. Thus, the versatility of the potentiometer becomes higher.

### Third Preferred Embodiment

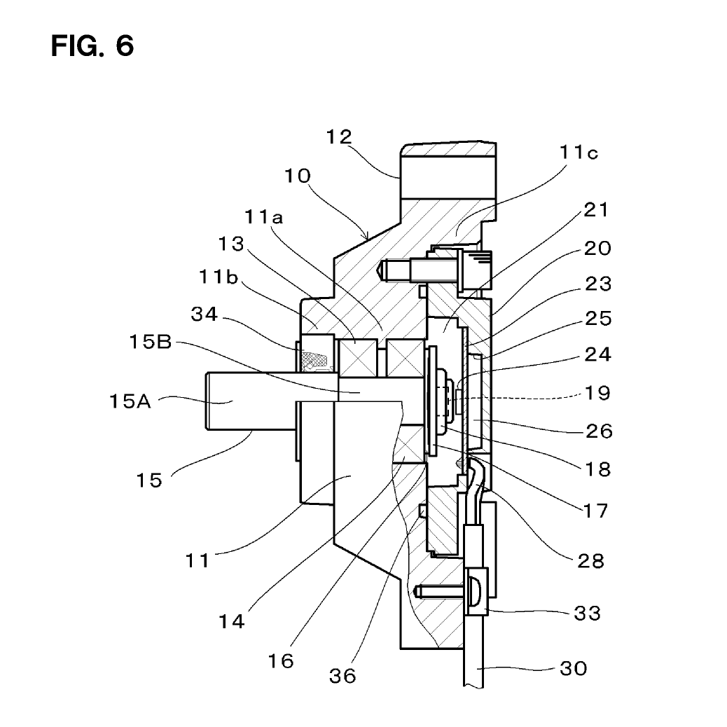

FIG. 6 is a sectional view of a contactless potentiometer according to a third preferred embodiment of the present invention, which is taken along the axis of a shaft. The same reference symbols as used above designate identical or equivalent portions.

The contactless potentiometer of the third preferred embodiment of the present invention is larger in size than the contactless potentiometers of the first and second preferred embodiments of the present invention. The flange portion 12 is preferably defined as a monolithic member with the body portion of the housing 10 at the outer circumference side of the sensor portion 11c. The cover member 20 is wholly arranged at the inner circumference side of the sensor portion 11c. The end surface of the cover member 20 is brought into contact with the side surface of the bearing holder portion 11a. Thus, the sensor area 21 is defined between the bearing holder portion 11a and the cover member 20. In case of the first and second embodiments, the cover member 20 is preferably fixed to the body portion 11 of the housing 10 by, for example, light press-fitting and bonding. In the third preferred embodiment, however, the cover member 20 is fixed to the body portion 11 preferably by bolts, for example. In this case, a groove 36 extending along one and the same perimeter about a center axis is annularly defined on the side surface of the bearing holder portion 11a in the position where the cover member 20 contacts the bearing holder portion 11a. After, for example, an O-ring is preferably fitted to the groove 36, the cover member 20 is attached to the side surface of the bearing holder portion 11a. Thus, the contact region between the cover member 20 and the side surface of the bearing holder portion 11a is sealed, thus providing a structure capable of increasing the sealing degree of the sensor area 21.

In the third preferred embodiment of the present invention, just like the first and second preferred embodiments of the present invention, the magnet 19 is embedded in the tip end portion of the shaft 15 facing the sensor area 21. On the sensor-area-side surface of the double-side-printed circuit board 23 attached to the cover member 20, the sensor IC 24 is arranged in a facing relationship with the magnet 19. Different kinds of components defining a processing circuit are preferably mounted around the sensor IC 24. In addition, the recess portion 25 is preferably defined on the surface of the cover member 20 facing the circuit board 23. Thus, the component-mounting spare space 26 is defined between the cover member 20 and the circuit board 23.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. (canceled)

2. A contactless potentiometer which includes a shaft and a magnet rotatable together with the shaft and detects a rotational angle of the shaft corresponding to a change in magnetic fields caused by the rotation of the magnet, the potentiometer comprising:
a housing arranged to rotatably support the shaft through a bearing, the magnet being held in a tip end portion of the shaft;
a cover member attached to the housing at a tip end side of the shaft and arranged to define a closed sensor area between the cover member and the housing, the tip end portion of the shaft extending into the sensor area; and
a circuit board mounted to the cover member at a side of the sensor area in a perpendicular or substantially perpendicular relationship with the shaft, the circuit board including a sensor-area-side surface on which a magnetic angle-detecting sensor IC is mounted so as to face the magnet; wherein
the cover member includes a recess portion arranged on a surface of the cover member facing the circuit board, the recess portion cooperating with the circuit board to define a component-mounting spare space.

3. The contactless potentiometer of claim 2, wherein the cover member includes an opening arranged to guide an external lead wire toward the circuit board, the opening filled with a sealing material after the lead wire is connected to the circuit board.

4. The contactless potentiometer of claim 2, wherein
a circular or substantially circular recess portion is concentrically arranged in the tip end portion of the shaft;
the recess portion is opened at a tip end of the shaft;
the magnet has a disc shape and an outer diameter equal or substantially equal to an inner diameter of the circular or substantially circular recess portion; and
the magnet is embedded in the circular or substantially circular recess portion.

5. The contactless potentiometer of claim 4, wherein the magnet includes two different magnetic poles each with a semicircular or substantially semicircular shape.

6. The contactless potentiometer of claim 4, wherein the sensor IC is arranged on an extension line of an axis of the shaft.

7. The contactless potentiometer of claim 2, wherein some or all of electronic components included in an output processing circuit that outputs a signal supplied from the sensor IC as an angle signal are mounted on the sensor-area-side surface of the circuit board together with the sensor IC.

8. The contactless potentiometer of claim 2, wherein the circuit board is defined by a double-side-printed board, and an electronic component is mounted on the circuit board in the component-mounting spare space.

9. The contactless potentiometer of claim 2, wherein a seal is interposed between a base-side outer circumferential surface of the shaft and an inner circumferential surface of the housing.
